(19) United States
(12) Patent Application Publication
(10) Pub. No.: US 2024/0203385 A1
(43) Pub. Date: Jun. 20, 2024

(54) ELECTRONIC KEYBOARD INSTRUMENT, ELECTRONIC INSTRUMENT SYSTEM, AND SOUND EMISSION CONTROL METHOD

(71) Applicant: CASIO COMPUTER CO., LTD., Tokyo (JP)

(72) Inventors: Makoto DANJYO, Tokyo (JP); Fumiaki OTA, Tokyo (JP); Atsushi NAKAMURA, Tokyo (JP)

(73) Assignee: CASIO COMPUTER CO., LTD., Tokyo (JP)

(21) Appl. No.: 18/535,323

(22) Filed: Dec. 11, 2023

(30) Foreign Application Priority Data
Dec. 16, 2022 (JP) 2022-200871

(51) Int. Cl. G10H 1/00; G10H 1/34

(52) U.S. Cl. CPC G10H 1/0008; G10H 1/344; G10H 2220/221; G10H 2220/271

(57) ABSTRACT

An electronic keyboard instrument includes, a keyboard in which a plurality of keys are arranged; a sound emitter; and a controller. In a case in which a slide operation of sliding on a plurality of keys on the keyboard is detected, the controller controls the sound emitter to emit a first musical tone corresponding to a plurality of first keys pressed by the slide operation and a second musical tone corresponding to an unpressed second key positioned between the plurality of first keys.

### CROSS-REFERENCE TO RELATED APPLICATIONS

The present application claims priority under Paris Convention to Japanese Patent Application No. 2022-200871, filed on 16 Dec. 2022, the disclosure of which, including description, claims, abstract and drawings, is incorporated herein by reference in its entirety.

### BACKGROUND

### Technical Field

The present invention relates to an electronic keyboard instrument, an electronic instrument system, and sound emission control method.

### Description of Related Art

As a technique to be able to change the sound at each semitone like a guitar in an electric keyboard instrument, for example, JP H9-44151 describes a technique in which a pitch bender is operated while a sound of a pressed key is emitted so as to be able to change the sound at each semitone.

### SUMMARY

According to one aspect of the present disclosure, the electronic keyboard instrument includes, a keyboard in which a plurality of keys are arranged; a sound emitter; and a controller, wherein in a case in which a slide operation of sliding on a plurality of keys on the keyboard is detected, the controller controls the sound emitter to emit a first musical tone corresponding to a plurality of first keys pressed by the slide operation and a second musical tone corresponding to an unpressed second key positioned between the plurality of first keys.

### BRIEF DESCRIPTION OF DRAWINGS

FIG. 1 is a block diagram showing a functional configuration of the electronic keyboard instrument.

FIG. 2 is a flowchart showing a flow of a sound emission control process executed by a controller shown in FIG. 1.

FIG. 3 is a flowchart showing a flow of a pressed key event process executed in step S3 shown in FIG. 2.

FIG. 4 is a diagram showing an example of data storage in a slide performance data table.

FIG. 5 is a flowchart showing a flow of a slide performance process performed by the controller shown in FIG. 1.

FIG. 6A and FIG. 6B are diagrams showing an effect of the sound emission control process shown in FIG. 2.

FIG. 7 is a diagram showing an example of a configuration of an electronic instrument system.

FIG. 8 is a diagram describing a difference between a sound emitted by white key glissando on a conventional electronic keyboard instrument and a sound emitted by slide guitar.

### DETAILED DESCRIPTION

Conventionally, in an electronic keyboard instrument such as an electronic piano or musical keyboard, when a finger is slid on a plurality of white keys (white key glissando) or a plurality of black keys (black key glissando), the sound usually changes one whole tone as the finger moves to the adjacent key.

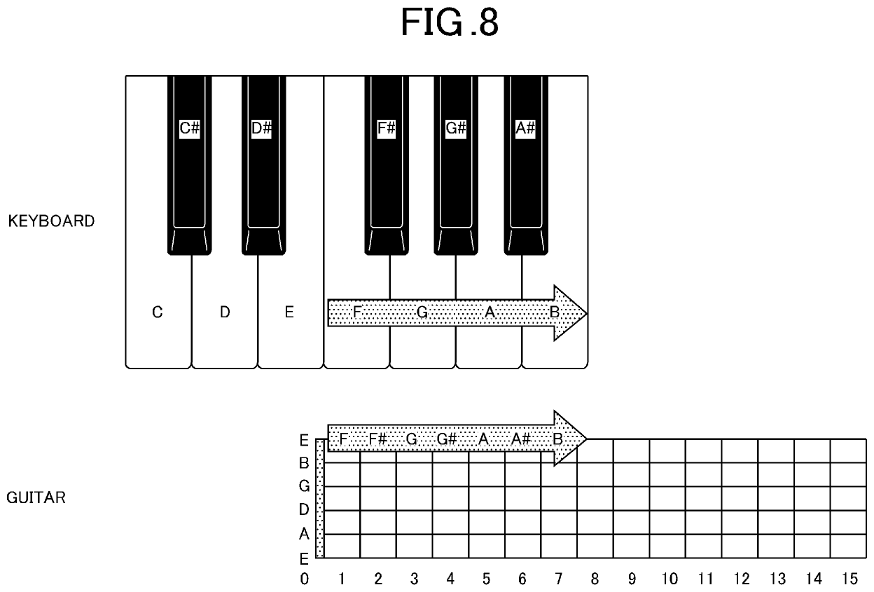

For example, as shown with an arrow in FIG. 8, when the finger slides from a key for playing F to a key for playing B, the sound becomes higher one whole tone at a time such as F to G to A to B.

On the other hand, in slide guitar which is to slide the finger while pressing a string, the sound changes one halftone at a time when the finger moves to the adjacent fret.

For example, as shown with an arrow in FIG. 8, when the finger is slid on the top E string from the first fret to the seventh fret, the sound becomes higher one halftone at a time such as F to F# to G to G# to A to A# to B.

In an electronic keyboard instrument, in order to change the sound one halftone at a time by playing the keyboard without using the pitch bender, it is necessary to sequentially press the aligning white keys and black keys. However, it is difficult to perform a glissando in which both the white keys and the black keys are swiftly pressed.

Therefore, in the conventional electronic keyboard instrument, it is difficult to play the electronic keyboard instrument by changing the sound quickly one halftone at a time like the slide guitar.

Hereinafter, embodiments are described with reference to the drawings. However, various limitations that are technically preferable to execute the present disclosure are described in the embodiments below. Therefore, the technical scope of the present disclosure is not limited to the embodiments described below and the illustrated examples.

### [Configuration of Electronic Keyboard Instrument 100]

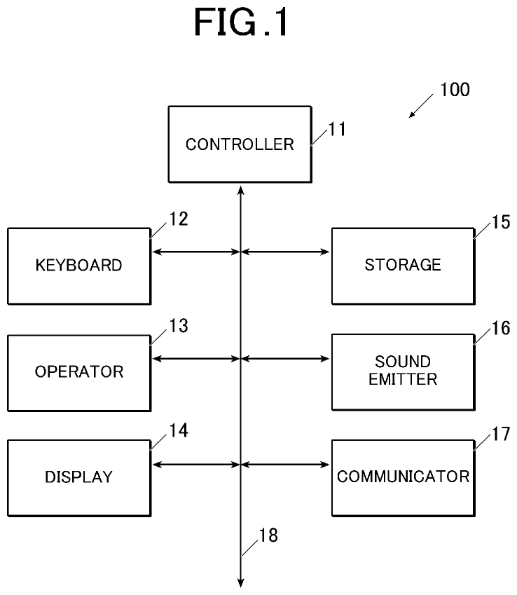

FIG. 1 is a block diagram showing a functional configuration of the electronic keyboard instrument 100 according to an embodiment of the present disclosure. For example, the electronic keyboard instrument 100 is an electronic instrument including a keyboard 12 in which a plurality of white keys and a plurality of black keys are arranged. Examples of the electronic keyboard instrument 100 include an electronic piano, a musical keyboard, and the like.

As shown in FIG. 1, the electronic keyboard instrument 100 includes a controller 11, a keyboard 12, an operator 13, a display 14, a storage 15, a sound emitter 16, and a communicator 17, and each unit is connected to each other through a bus 18.

The controller 11 is a computer and includes at least one central processing unit (CPU), a read only memory (ROM), a random access memory (RAM), and the like. The CPU of the controller 11 reads programs and data stored in the ROM. The RAM is used as the work area for the CPU. The CPU executes various processes to centrally control the units of the electronic keyboard instrument 100.

The keyboard 12 includes a plurality of keys (play operators) to which a different pitch is assigned for each halftone and a detector that detects the pressed or released key. The keyboard 12 outputs the information such as the pitch, a velocity value, etc. of the pressed or released key (note number) to the controller 11.

The controller 11 temporarily stores the information such as the pitch and the velocity value of the pressed or released key (note number), and the timing that the press or release is detected.

The operator 13 includes various switches such as a song selection switch, play switch, cursor switch and the like, and operation buttons. Information on the operation of the various switches and operation buttons by the user is output to the controller 11.

The display 14 includes a liquid crystal display (LCD), and displays various screens according to an instruction of a display signal input from the controller 11.

The storage 15 includes a nonvolatile semiconductor memory, a hard disk, or the like, and stores various kinds of data. The storage 15 is not limited to being provided inside the electronic keyboard instrument 100, and may include an external storage medium that can be attached to and detached from the electronic keyboard instrument 100. The storage 15 may store a program to operate the electronic keyboard instrument 100 and the parameters necessary to execute the program.

The sound emitter 16 includes a sound source, a D/A converter, an amplifier, and a speaker. According to instructions from the controller 11, the sound emitter 16 reads from the sound source the waveform data stored in advance in a waveform ROM provided in the sound source or generates waveform data. Then, the sound emitter 16 outputs the sound based on the waveform data from the speaker through the D/A converter and the amplifier.

The communicator 17 includes a wireless unit or a wired unit to perform communication with external devices. The communicator 17 performs data communication with external devices based on the control by the controller 11.

### [Operation of Electronic Keyboard Instrument 100]

Next, the operation of the electronic keyboard instrument 100 is described.

Usually in an electronic keyboard instrument, in order to change the sound one halftone at a time by playing the keyboard, it is necessary to sequentially press the aligning white keys and black keys. However, it is difficult to perform a glissando in which both the white keys and the black keys are swiftly pressed. Therefore, in the conventional electronic keyboard instrument, it is difficult to achieve a performance in which the sound is changed quickly one halftone at a time like the slide guitar.

Therefore, in the electronic keyboard instrument 100 according to the present embodiment, when the glissando of the white key or the black key is performed from a pressed key with a velocity value larger than a preset value (threshold), that is, when the slide of the finger on a plurality of white keys (white key slide operation) or the slide of the finger on the plurality of black keys (black key slide operation) is performed from a pressed key with the velocity value larger than the preset value, control is performed so that a musical tone corresponding to a second key that is not pressed between the plurality of first keys that are pressed by the slide operation is emitted. With this, it is possible to change the sound one halftone at a time swiftly like a guitar slide on a guitar by glissando of the white key or the black key.

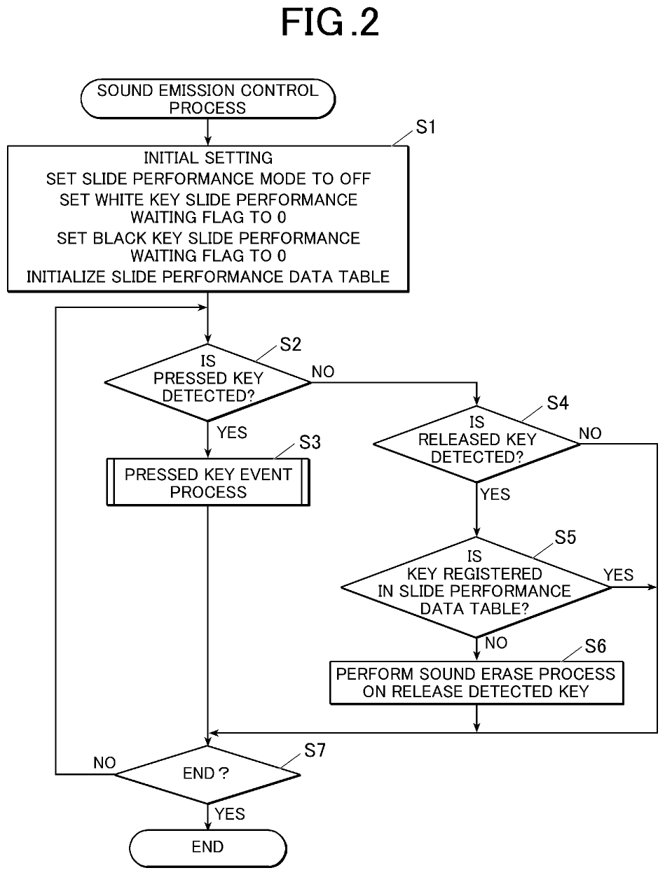

FIG. 2 is a flowchart showing a flow of a sound emission control process performed by the controller 11 of the electronic keyboard instrument 100. For example, the sound emission control process is performed by the CPU of the controller 11 in coordination with the program stored in the ROM when the power of the electronic keyboard instrument 100 is turned on.

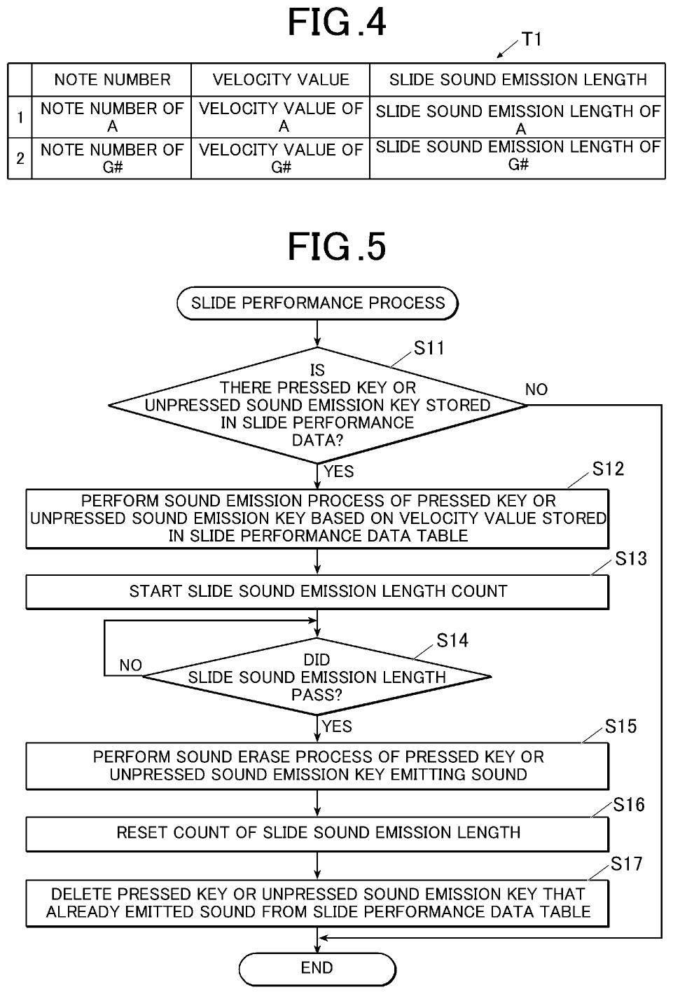

First, the controller 11 sets initial settings (step S1). In step S1, the controller 11 initializes variables and tables in the RAM used in a pressed key event process and slide performance process which are described later. For example, the controller 11 initially sets a slide performance mode which is a variant used in the key press event process described later to be off. The slide performance mode is a variable set to on when the slide operation (slide performance, glissando) on the white keys or the black keys is detected. The controller 11 sets the white key slide performance waiting flag and black key slide performance waiting flag to 0. The white key slide performance waiting flag is set to 1 if the white key is pressed at a velocity value larger than the set value when the slide performance mode is turned off. The black key slide performance waiting flag is set to 1 if the black key is pressed at a velocity value larger than the set value when the slide performance mode is turned off. The controller 11 initializes the slide performance data table T1 (see FIG. 4).

Next, the controller 11 determines whether the pressed key is detected by the keyboard 12 (step S2).

In a case in which it is determined that the pressed key is detected (step S2: YES), the controller 11 performs the pressed key event process (step S3).

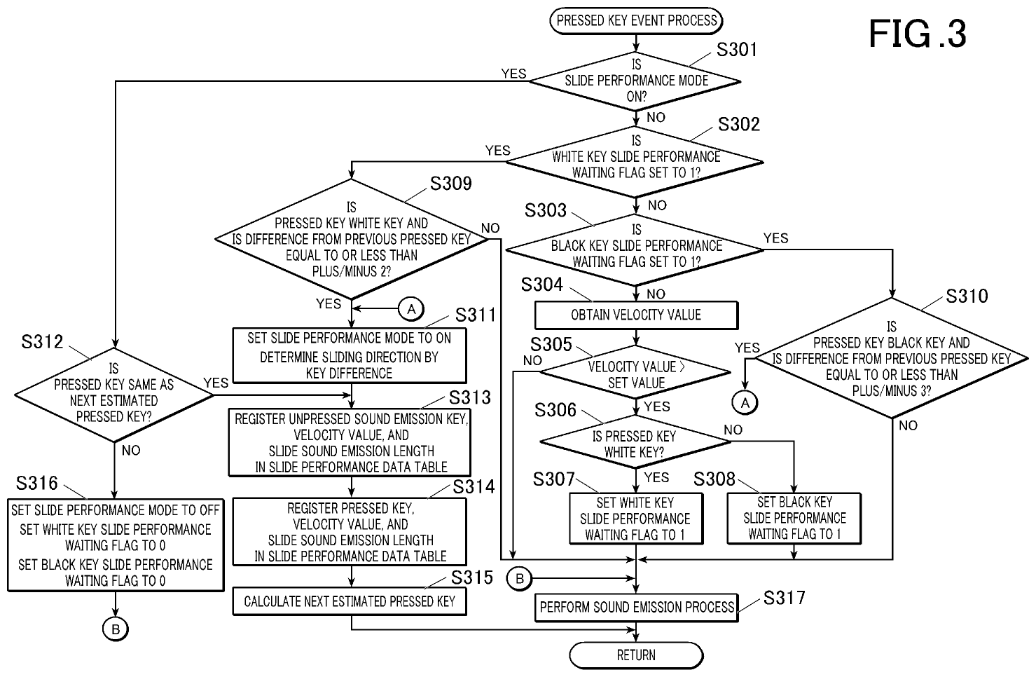

FIG. 3 is a flowchart showing a flow of a pressed key event process in step S3. The pressed key event process is performed by the CPU of the controller 11 in coordination with the program stored in the ROM.

First, the controller 11 determines whether the slide performance mode is set to on (step S301).

In a case in which it is determined that the slide performance mode is not set to on (step S301; NO), the controller 11 determines whether the white key slide performance waiting flag is 1 (step S302).

In a case in which it is determined that the white key slide performance waiting flag is not 1 (step S302; NO), the controller 11 determines whether the black key slide performance waiting flag is 1 (step S303).

In a case in which it is determined that the black key slide performance waiting flag is not 1 (step S303; NO), the controller 11 obtains the velocity value of the pressed key (step S304).

Next, the controller 11 determines whether the obtained velocity value exceeds the predetermined set value (threshold) (step S305).

In a situation in which it is determined that the obtained velocity value does not exceed the predetermined set value (step S305; NO), the controller 11 performs the sound emission process (step S317). That is, the controller 11 controls the sound emitter 16 to emit a musical tone with the pitch and the velocity value according to the pressed key and the process proceeds to step S7 in FIG. 2.

In a case it is determined that the obtained velocity value exceeds the predetermined set value (step S305; YES), the controller 11 determines whether the pressed key is the white key (step S306).

In a case it is determined that the pressed key is the white key (step S306; YES), the controller 11 sets the white key slide performance waiting flag to 1 (step S307), and controls the sound emitter 16 to emit the musical tone with the pitch and the velocity value according to the pressed key (step S317). With this, the process proceeds to step S7 in FIG. 2.

In a case it is determined that the pressed key is the black key (step S306; NO), the controller 11 sets the black key slide performance waiting flag to 1 (step S308), and controls the sound emitter 16 to emit the musical tone with the pitch and the velocity value according to the pressed key (step S317). With this, the process proceeds to step S7 in FIG. 2.

In step S302, in a case in which it is determined that the white key slide performance waiting flag is 1 (step S302; YES), the controller 11 determines whether the pressed key is the white key and whether the difference between the previously pressed key and the present pressed key (difference of position) is equal to or smaller than plus/minus 2 (step S309).

For example, the difference between the previously pressed key and the present pressed key can be obtained by subtracting the note number of the previously pressed key from the present pressed key.

In a case it is determined that the pressed key is not the white key or the difference between the previously pressed key and the present pressed key is not equal to or smaller than plus/minus 2 (step S309; NO), the controller 11 controls the sound emitter 16 to emit the musical tone with the pitch and the velocity value according to the pressed key (step S317). With this, the process proceeds to step S7 in FIG. 2.

In a case it is determined that the pressed key is the white key and that the difference between the previously pressed key and the present pressed key is plus/minus 2 or smaller (step S309; YES), the controller 11 determines that the slide operation is detected, sets the slide performance mode to on, and determines a sliding direction from the difference between the previously pressed key and the present pressed key (step S311). With this, the process proceeds to step S313. In a case that the difference between the previously pressed key and the present pressed key is plus, it is determined that the sliding is in the left direction. In a case that the difference is minus, it is determined that the sliding is in the right direction.

In step S303, in a case in which it is determined that the black key slide performance waiting flag is 1 (step S303; YES), the controller 11 determines whether the pressed key is the black key and whether the difference between the previously pressed key and the present pressed key (difference of position) is equal to or smaller than plus/minus 3 (step S310).

For example, the difference between the previously pressed key and the present pressed key can be obtained by subtracting the note number of the previously pressed key from the present pressed key.

In a case it is determined that the pressed key is not the black key or the difference between the previously pressed key and the present pressed key is not equal to or smaller than plus/minus 3 (step S310; NO), the controller 11 controls the sound emitter 16 to emit the musical tone with the pitch and the velocity value according to the pressed key (step S317). With this, the process proceeds to step S7 in FIG. 2.

In a case it is determined that the pressed key is the black key and that the difference between the previously pressed key and the present pressed key is plus/minus 3 or smaller (step S310; YES), the controller 11 determines that the slide operation is detected, sets the slide performance mode to on, and determines a sliding direction from the difference between the previously pressed key and the present pressed key (step S311). With this, the process proceeds to step S313. In a case that the difference between the previously pressed key and the present pressed key is plus, it is determined that the sliding is in the left direction. In a case that the difference is minus, it is determined that the sliding is in the right direction.

Here, the difference of the note numbers between the adjacent white keys is equal to or smaller than plus/minus 2. That is, in a case that the white key slide performance waiting flag is 1, the present pressed key is a white key, and the difference between the previously pressed key and the present pressed key is plus/minus 2 or smaller, it is possible to determine that the slide operation of the white key (white key glissando) is detected. Moreover, the difference of the note numbers between the adjacent black keys is equal to or smaller than plus/minus 3. That is, in a case that the black key slide performance waiting flag is 1, the present pressed key is a black key, and the difference between the previously pressed key and the present pressed key is plus/minus 3 or smaller, it is possible to determine that the slide operation of the black key (black key glissando) is detected.

In step S313, the controller 11 registers an unpressed key sound emission key, velocity value, and slide sound emission length in a slide performance data table T1 (step S313).

There is 0 or 1 black key between adjacent white keys. When the finger slides on the white keys, the second black key between the pressed plurality of first white keys is not pressed and is to be the unpressed key. There are 1 or 2 white keys between adjacent black keys. When the finger slides on the black keys, the second white key between the pressed plurality of first black keys is not pressed and is to be the unpressed key. According to the present embodiment, the controller 11 controls the sound so that the sound of the unpressed key is emitted between the emitted sound of the previously pressed key and the emitted sound of the present pressed key. In step S313, the note number of the key that is not pressed positioned between the previously pressed key and the present pressed key is registered as the unpressed key sound emission key in the slide performance data table T1. The velocity value and the slide sound emission length (length of sound emission) when the sound of the unpressed key sound emission key is emitted is calculated (determined) and this is also registered in the performance data table T1.

The velocity value of the unpressed key sound emission key is calculated based on the velocity value of the previously pressed key and the velocity value of the present pressed key. For example, as shown in (formula 1), the average between the velocity value of the previously pressed key (first velocity value) and the velocity value of the present pressed key (first velocity value) can be calculated as the velocity value (second velocity value) of the unpressed sound emission key between the above keys.

$$velocity value of unpressed sound emission key = ( velocity value of previously pressed key + velocity value of present pressed key ) / 2 \qquad ( formula 1 )$$

The slide sound emission length of the unpressed sound emission key can be calculated based on a difference of the time between the previously pressed key and the present pressed key and the number of unpressed key sound emission keys. For example, the value can be obtained from (formula 2).

slide sound emission length of unpressed sound emission key=(timing of note turning on for present pressed key−timing of note turning on for previously pressed key)/(number of unpressed sound emission keys+1) (formula 2)

For example, in a situation in which the finger slides on black keys from A# to G#, the slide sound emission length of A which is the unpressed sound emission key between the pressed key of A# and the pressed key of G# is to be the following.

slide sound emission length of A=(timing that the note G# turns on−timing that the note A# turns on)/(1+1)

Next, the controller 11 registers the pressed key, the velocity value, and the slide sound emission length in the slide performance data table T1 (step S314).

In step S314, the controller 11 registers the note number and the velocity value of the present pressed key in the slide performance data table T1. Moreover, the slide sound emission length of the pressed key is calculated, the slide sound emission length is corresponded with the note number and the velocity value of the pressed key, and the above are registered in the slide performance data table T1. The slide sound emission length of the pressed key is the same as the slide emission length of the unpressed sound emission key as described above.

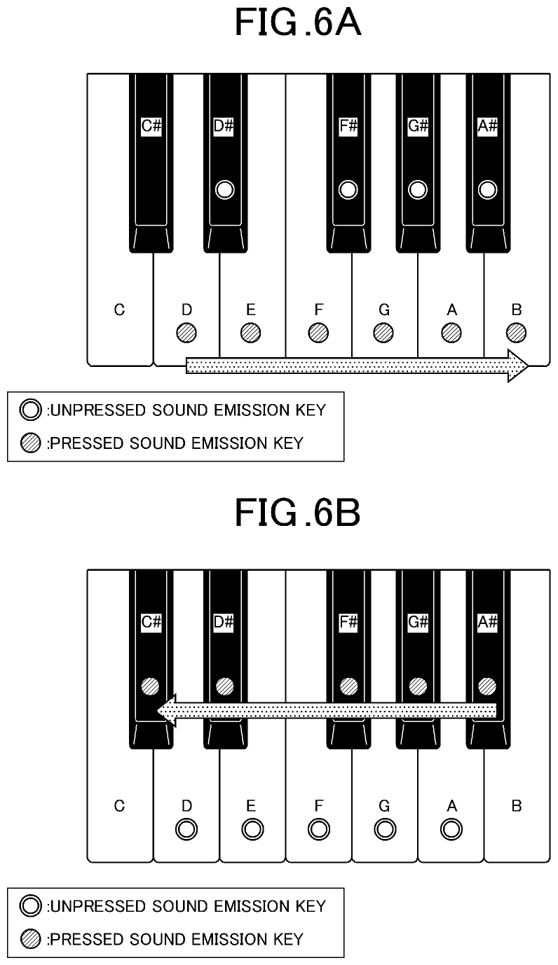

FIG. 4 is a diagram showing an example of data storage in the slide performance data table T1. The slide performance data table T1 stores the note number, the velocity value, and the slide sound emission length of the unpressed sound emission key or the pressed key corresponded to each other as the slide performance data. The slide performance data table T1 stores and reads the data by First In First Out (FIFO). The slide performance data shown in FIG. 4 shows an example of data storage of the slide performance data table T1 registered when G# is pressed while sliding on the black key in the left direction from A#(see FIG. 6B).

Next the controller 11 calculates the next estimated pressed key based on the sliding direction (step S315), and the process proceeds to step S7 shown in FIG. 2. The calculated next estimated pressed key is temporarily stored in the RAM.

Here, the sound of the pressed key or the unpressed sound emission key registered in the slide performance data table T1 is emitted in the later-described slide performance process (see FIG. 5).

In step S301, in a case in which it is determined that the slide performance mode is turned on (step S301; YES), the controller 11 determines whether the pressed key is the same as the next estimated pressed key (step S312).

In a case in which it is determined that the pressed key is the same as the next estimated pressed key (estimated key) (step S312; YES), the controller 11 performs the process in the above-described steps S313 to S315 (steps S313 to S315), and the process proceeds to step S7 as shown in FIG. 2.

That is, the note number, the velocity value and the slide sound emission length of the unpressed sound emission key and the pressed key are registered in the slide performance data table T1.

In a case in which it is determined that the pressed key is not the same as the next estimated pressed key (step S312; NO), the controller 11 sets the slide sound emission mode to off and sets the white key slide performance waiting flag and the black key slide performance waiting flag to 0 (step S316). Then, the controller 11 controls the sound emitter 16 to emit the musical tone with the pitch and the velocity value according to the pressed key (step S317). With this, the process proceeds to step S7 shown in FIG. 2.

Returning to FIG. 2, in step S2, in a case in which it is determined that the pressed key is not detected (step S2; NO), the controller 11 determines whether the release from the key is detected from the keyboard 12 (step S4).

In a case in which it is determined that the release of the key is detected (step S4; YES), the controller 11 determines whether the key in which the release is detected (release detected key) is the key registered in the slide performance data table T1 (step S5).

In a case in which it is determined that the release detected key is not the key registered in the slide performance data table T1 (step S5; NO), the controller 11 controls the sound emitter 16 to perform a sound erase process on the release detected key (step S6). With this, the process proceeds to step S7.

In a case that it is determined that the release detected key is registered in the slide performance data table T1 (step S5; YES), the controller 11 controls the process to proceed to step S7.

In step S7, the controller 11 determines whether the sound emission control process ends (step S7). For example, in a case that the power source is turned off, the controller 11 determines that the sound emission control process ends.

In a case in which it is determined that the sound emission control process does not end (step S7; NO), the controller 11 controls the process to return to step S2.

In a case in which it is determined that the sound emission control process ends (step S7; YES), the controller 11 ends the sound emission control process.

The controller 11 performs the slide performance process each time a predetermined amount of time passes during the sound emission control process. Then, the controller 11 controls the sound emitter 16 and emits the sound of the unpressed sound emission key and the pressed key registered in the slide performance data table T1.

FIG. 5 is a flowchart showing a flow of the slide performance process. The slide performance process is performed by the CPU of the controller 11 in coordination with the program stored in the ROM.

In the slide performance process, the controller 11 first determines whether the pressed key or the unpressed sound emission key is stored in the slide performance data table T1 (step S11).

In a case in which it is determined that there is no pressed key or unpressed key sound emission key stored in the slide performance data table T1 (step S11; NO), the controller 11 ends the slide performance process.

In a case in which it is determined that the pressed key or the unpressed sound emission key is stored in the slide performance data table T1 (step S11; YES), the controller 11 reads one of the slide performance data from the slide performance data table T1. Based on the velocity value of the read slide performance data, the controller 11 controls the sound emitter 16 to emit the musical tone with the pitch corresponding to the pressed key or the unpressed sound emission key (step S12), and starts the count of the slide sound emission length (step S13). The controller 11 performs the count of the slide sound emission length at intervals of a certain amount of time.

The controller 11 stands by until the slide sound emission length passes (step S14). In a case in which it is determined that the slide sound emission length passed (step S14; YES), the controller 11 controls the sound emitter 16 and performs the sound erase process of the pressed key or the unpressed sound emission key that is emitting sound (step S15).

Next, the controller 11 resets the count of the slide sound emission length (step S16). Then, the controller 11 erases the slide sound emission data of the pressed key or the unpressed sound emission key from the slide performance data table T1 after the sound emission ends (step S17), and the slide performance process ends.

FIG. 6A and FIG. 6B are diagrams showing an example of the pressed key and the unpressed sound emission key for which the sound is emitted in a case that the white key slide operation and the black key slide operation are performed on the electronic keyboard instrument 100. According to the electronic keyboard instrument 100, for example, in a case in which the white key slide operation as shown in FIG. 6A is performed, the sound of the black key which is the unpressed key between the pressed white keys is also emitted. As shown in FIG. 6B, in a case in which the black key slide operation is performed, the sound of the white key which is the unpressed key between the pressed black keys is also emitted. Therefore, in the electronic keyboard instrument 100, it is possible to achieve a performance in which the sound is changed quickly one halftone at a time like the slide guitar.

In an exemplary description with reference to the diagram shown in FIG. 6B, in a state in which the slide performance mode is off (step S301; NO), in a case in which it is detected that the A# key is pressed at a velocity value equal to or larger than a set value, the black key slide performance waiting flag is set to 1 (step S308), and the sound emission process that emits the musical tone with the pitch of A# is performed (step S317). Next, in a case in which it is detected that the G# key is pressed, it is determined that the pressed key is the black key and the difference from the previously pressed key is equal to or smaller than plus/minus 3 (step S310; YES), and the slide performance mode is set to on (step S311). Then, A is registered in the slide performance data table T1 as the unpressed sound emission key (step S313). The second velocity value determined based on the first velocity value of A# and G# is registered in the slide performance data table T1 as the velocity value. Then, G# is registered in the slide performance data table T1 as the pressed key (step S314). Then, F # is calculated to be the next estimated pressed key (step S315). Next, in a case in which it is detected that F# key is pressed, the slide performance mode is set to on (step S301; YES) and the pressed key is the same as the next estimated pressed key (step S312; YES). Then, G is registered in the slide performance data table T1 as the unpressed sound emission key (step S313). The data registered in the slide performance data table T1 is executed by a process in a different task and the sound emission process is performed. With this, the sound emission process is performed for not only the musical tone corresponding to the pressed first key (for example, A# and G#), but also for the musical tone corresponding to the unpressed second key (for example, A and G).

As described above, in a case in which a slide operation of sliding on a plurality of keys of the keyboard 12 in which a plurality of keys are arranged is detected, the controller 11 of the electronic keyboard instrument 100 controls the sound emitter 16 to emit both the first musical tone corresponding to the plurality of first keys pressed by the slide operation and the second musical tone corresponding to the unpressed second key positioned between the plurality of first keys.

For example, in a case that a white key slide operation of sliding on a plurality of white keys of the keyboard 12 is detected, the controller 11 controls the sound emitter 16 to emit the musical tone corresponding to the plurality of first white keys pressed by the white key slide operation and the unpressed black key between the plurality of first white keys. For example, in a case that a black key slide operation of sliding on a plurality of black keys of the keyboard 12 is detected, the controller 11 controls the sound emitter 16 to emit the musical tone corresponding to the plurality of first black keys pressed by the black key slide operation and the unpressed white key between the plurality of first black keys.

Therefore, it is possible to achieve a performance in which the sound is changed quickly one halftone at a time like the slide guitar.

In a case that the slide operation starts by pressing the key at the velocity value that exceeds a predetermined threshold, the controller 11 controls the sound emitter 16 to emit the musical tone corresponding to the plurality of first keys pressed by the slide operation and the unpressed second key between the plurality of pressed first keys.

Therefore, it is possible to switch whether or not to control the sound emitter 16 to emit the musical tone corresponding to the unpressed key during the slide operation with the degree of the velocity value when the slide operation starts.

The controller 11 determines the length that the sound of the second key is emitted based on the difference of the time of the two pressed first keys pressed successively in the slide operation and the number of unpressed second keys positioned between the two first keys. Then, the controller 11 controls the sound emitter 16 to emit the musical tone corresponding to the second key at the determined length. Therefore, it is possible to emit the musical tone corresponding to the unpressed key at a suitable length according to the speed of pressing the key in the sliding operation.

At least based on the first velocity value corresponding to the key included in the plurality of first keys, the controller 11 determines the second velocity value corresponding to the unpressed second key positioned between the two first keys. Based on the determined second velocity value, the controller 11 controls the sound emitter 16 to emit the musical tone corresponding to the second key.

Therefore, it is possible to emit the musical tone corresponding to the unpressed key with the strength according to the velocity value of the pressed key in the slide operation.

In a situation in which the difference of the positions of the two white keys pressed successively is equal to or less than plus/minus 2, the controller 11 determines that the white key slide operation is detected and controls the sound emitter 16 in a manner as described above. Therefore, it is possible to suitably detect the white key sliding operation and to achieve the performance of changing the sound by semitone quickly according to the sliding operation of the white key.

In a situation in which the difference of the positions of the two black keys pressed successively is equal to or less than plus/minus 3, the controller 11 determines that the black key slide operation is detected and controls the sound emitter 16 in a manner as described above. Therefore, it is possible to suitably detect the black key sliding operation and to achieve the performance of changing the sound by semitone quickly according to the sliding operation of the black key.

Based on the relation of the positions of the two keys pressed successively during the slide operation, the controller 11 estimates the next pressed key. In a case in which the next pressed key is the estimated key, the controller 11 determines that the slide operation is detected.

Therefore, it is possible to suitably detect the sliding operation considering the direction also and to achieve the performance of changing the sound by semitone quickly according to the sliding operation.

The description according to the above embodiments are merely one suitable example of the present invention and the present invention is not limited to the above.

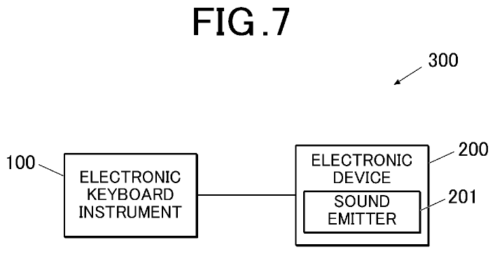

For example, as shown in FIG. 7, the electronic keyboard instrument 100 may be connected to an electronic device 200 such as a tablet or a laptop personal computer through a communicator 17. With this, an electronic instrument system 300 can be structured. Then, the controller 11 may control the sound emitter 201 of the electronic device 200 connected through the communicator 17 to emit the musical tone corresponding to the key pressed on the electronic keyboard instrument 100. In a case in which the slide operation of sliding the finger on the plurality of keys of the keyboard 12 is detected, the controller 11 may control the sound emitter 201 to emit the musical tone corresponding to the plurality of keys pressed in the slide operation and the unpressed key between the plurality of pressed keys.

According to the above embodiments, a semiconductor memory or a hard disk can be used as the computer readable storage medium storing the program regarding the above disclosure but the examples are not limited to the above. As the computer readable medium, a SSD, a portable recording/storage medium, such as a CD-ROM, can also be used. A carrier wave is also applied as a medium providing the program data according to the present invention via a communication line.

In addition to the above, detailed configurations and detailed operation of the components of the electronic keyboard instrument can also be appropriately modified without departing from the scope of the present invention.

Although the embodiments of the invention have been described above, the technical scope of the invention is not limited to the embodiments described above, but is defined based on the scope of the claims. Furthermore, the technical scope of the invention includes equivalents in which modifications that are not related to the essence of the invention are added to the scope of the claims.

1. An electronic keyboard instrument comprising:
a keyboard in which a plurality of keys are arranged;
a sound emitter; and
a controller,
wherein
in a case in which a slide operation of sliding on a plurality of keys on the keyboard is detected, the controller controls the sound emitter to emit a first musical tone corresponding to a plurality of first keys pressed by the slide operation and a second musical tone corresponding to an unpressed second key positioned between the plurality of first keys.

2. The electronic keyboard instrument according to claim 1, wherein the controller,
determines a second velocity value corresponding to the second key based on at least a first velocity value corresponding to a key included in the plurality of first keys, and
controls the sound emitter to emit the second musical tone corresponding to the second key based on the determined second velocity value.

3. The electronic keyboard instrument according to claim 1, wherein the controller,
determines a length that the second musical tone of the second key is emitted based on a difference of time of the two pressed first keys pressed successively in the slide operation and the number of unpressed second keys positioned between the two first keys, and
controls the sound emitter to emit the second musical tone corresponding to the second key at the determined length.

4. The electronic keyboard according to claim 1, wherein,
the keyboard includes a plurality of white keys and a plurality of black keys that are arranged in an array, and
in a case in which a white key slide operation of sliding on a plurality of white keys of the keyboard is detected, the controller controls the sound emitter to emit the first musical tone corresponding to the plurality of first white keys pressed by the white key slide operation and the second musical tone corresponding to the unpressed black key between the plurality of first white keys.

5. The electronic keyboard according to claim 1, wherein,
the keyboard includes a plurality of white keys and a plurality of black keys that are arranged in an array, and
in a case in which a black key slide operation of sliding on a plurality of black keys of the keyboard is detected, the controller controls the sound emitter to emit the first musical tone corresponding to the plurality of first black keys pressed by the black key slide operation and the second musical tone corresponding to the unpressed white key between the plurality of first black keys.

6. The electronic keyboard according to claim 1, wherein the controller,
estimates a next pressed key based on a relation of positions of two keys pressed successively in the slide operation, and
in a case in which the next pressed key is the estimated key, determines that the slide operation is detected.

7. An electronic instrument system comprising:
an electronic keyboard instrument including a keyboard and a controller; and
an electronic device including a sound emitter,
wherein,
in a case in which a slide operation of sliding on a plurality of keys on the keyboard is detected, the controller controls the sound emitter to emit a first musical tone corresponding to a plurality of first keys pressed by the slide operation and a second musical tone corresponding to an unpressed second key between the plurality of first keys.

8. A control method performed by a controller of a keyboard instrument, the method comprising:
in a case in which a slide operation of sliding on a plurality of keys on a keyboard is detected, controlling the sound emitter to emit a first musical tone corresponding to a plurality of first keys pressed by the slide operation and a second musical tone corresponding to an unpressed second key positioned between the plurality of first keys.

9. The control method according to claim 8, wherein the controller,
determines a second velocity value corresponding to the second key based on at least a first velocity value corresponding to a key included in the plurality of first keys, and
controls the sound emitter to emit the second musical tone corresponding to the second key based on the determined second velocity value.

10. The control method according to claim 8, wherein the controller,
determines a length that the second musical tone of the second key is emitted based on a difference of time of the two pressed first keys pressed successively in the slide operation and the number of unpressed second keys positioned between the two first keys, and
controls the sound emitter to emit the second musical tone corresponding to the second key at the determined length.

11. The control method according to claim 8, wherein,
the keyboard includes a plurality of white keys and a plurality of black keys that are arranged in an array, and
in a case in which a white key slide operation of sliding on a plurality of white keys of the keyboard is detected, the controller controls the sound emitter to emit the first musical tone corresponding to the plurality of first white keys pressed by the white key slide operation and the second musical tone corresponding to the unpressed black key between the plurality of first white keys.

12. The control method according to claim 8, wherein,
the keyboard includes a plurality of white keys and a plurality of black keys that are arranged in an array, and
in a case in which a black key slide operation of sliding on a plurality of black keys of the keyboard is detected, the controller controls the sound emitter to emit the first musical tone corresponding to the plurality of first black keys pressed by the black key slide operation and the second musical tone corresponding to the unpressed white key between the plurality of first black keys.

13. The control method according to claim 8, wherein the controller,
estimates a next pressed key based on a relation of positions of two keys pressed successively in the slide operation, and
in a case in which the next pressed key is the estimated key, determines that the slide operation is detected.
